(19) United States
(12) Patent Application Publication
(10) Pub. No.: US 2008/0217331 A1
(43) Pub. Date: Sep. 11, 2008

(54) Reservoir For a Water Treatment Device and Manufacturing Method of the Reservoir

(75) Inventors: Francesco Zinoni, San Gervasio Bresciano (IT); Lorenzo Bertoli, Cignano Di Offlaga (IT)

Correspondence Address: SHOEMAKER AND MATTARE, LTD, 10 POST OFFICE ROAD - SUITE 110, SILVER SPRING, MD, 20910, US

(73) Assignee: HYDRO SYSTEM TREATMENT S.R.L., San Gervasio Bresciano (IT)

(21) Appl. No.: 10/598,211

(22) PCT Filed: Apr. 7, 2004
(86) PCT No.: PCT/IT2004/000182

§ 371 Date: Aug. 21, 2006

(51) Int. Cl. B29D 22/00; B65D 90/02

(52) U.S. Cl. 220/62.19; 264/239

(57) ABSTRACT

A tank for a water-treatment device, comprising an internal coating (2), a hollow insert (10), with a collar (14) projecting externally from the coating (2), and an external covering (40), which is created by wrapping a bundle of glass fibre buried in a polymeric matrix around the coating. The covering (40) comprises a portion of covering (50), which covers the collar (14), at least partially, reinforcing the connection between the insert (10) and the coating (2). The tank (1) is made by blowing or using a rotational press and subsequently wrapping the bundle of fibre buried in the matrix to make the covering (40) and the portion of covering (50).

The present invention refers to a tank for a water-treatment device, for example a device for decalcifying the water supplied by an aqueduct.

Devices for treating the water supplied by a water system, for example of an aqueduct, are becoming increasingly popular, both in the field of domestic and industrial use.

For example, more and more often, homes or condominiums are equipped with such a type of device, for example to decalcify the water, or in any case, alter its physical-chemical characteristics and make it more suitable for uses, for example as drinking water.

Similarly, the water supplied by the water network or taken from rivers, lakes or from the sea, is treated in industry before being used in a particular production cycle to make it more suitable for this cycle.

The water-treatment devices are inserted upstream of the domestic or industrial distribution network, and generally comprise a tank that is connected to the water network.

During device operation, these tanks contain water at a high pressure compared with the characteristics of the distribution network downstream of the device, and a mass of organic resins, whose composition is connected with the specific treatment, to which the water is subjected.

In any case, said tanks are made of a material that is suitable for contact with the water, which may be used as drinking water.

To cope with the elevated working pressure or satisfy the difficult conditions to which these tanks are subjected during the tests foreseen by regulations in this field, said tanks have an internal coating and a cover for reinforcement.

It is known how the most critical area in the sector for resistance to working pressure or testing is the opening area of the tank, which is generally fitted with connection devices, such as a thread, for connection to a device valve.

The object of the present invention is to create a tank for a water-treatment device fitted with an opening that has such characteristics to increase resistance to elevated working pressure or tank testing.

This object is achieved by means of a tank made according to claim 1. The claims depending on this describe possible variations. According to the present invention, the tank can be made in accordance with the construction method according to claim 18. Claims depending on this describe variations of implementation of said method.

The characteristics and advantages of the tank according to the present invention will appear evident from the description reported below of an example of embodiment, given as an example, which is not limiting, in accordance with the accompanying drawings, wherein:

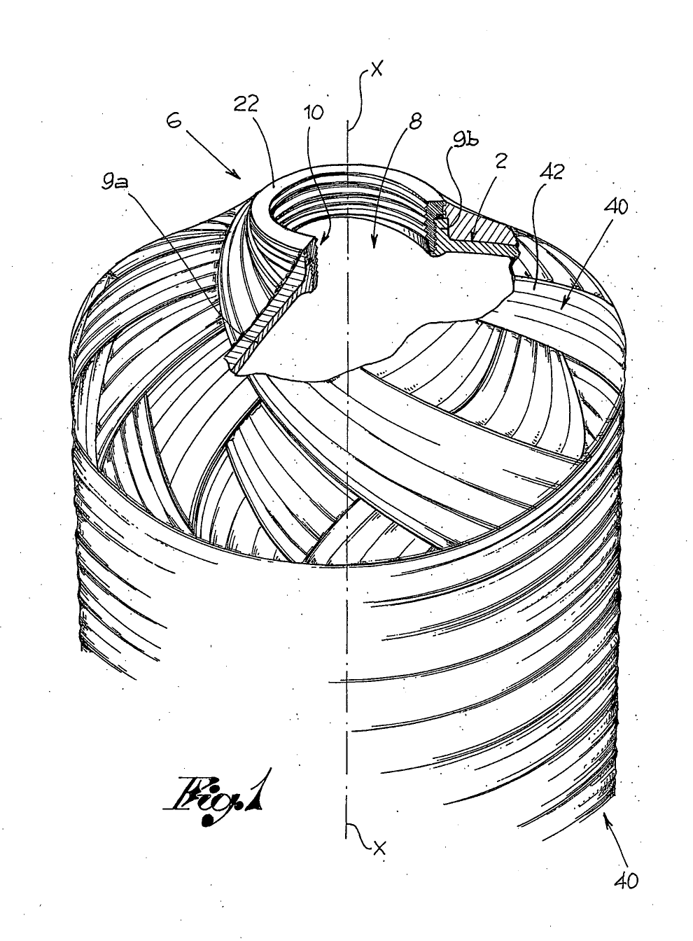

FIG. 1 shows a partially sectioned perspective view of a tank according to the present invention;

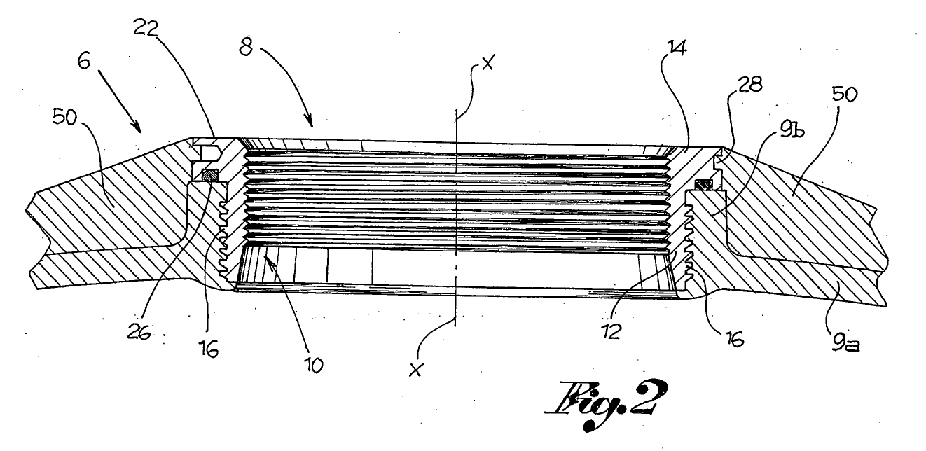

FIG. 2 represents a sectioned surface view of an opening area of the tank in FIG. 1, and

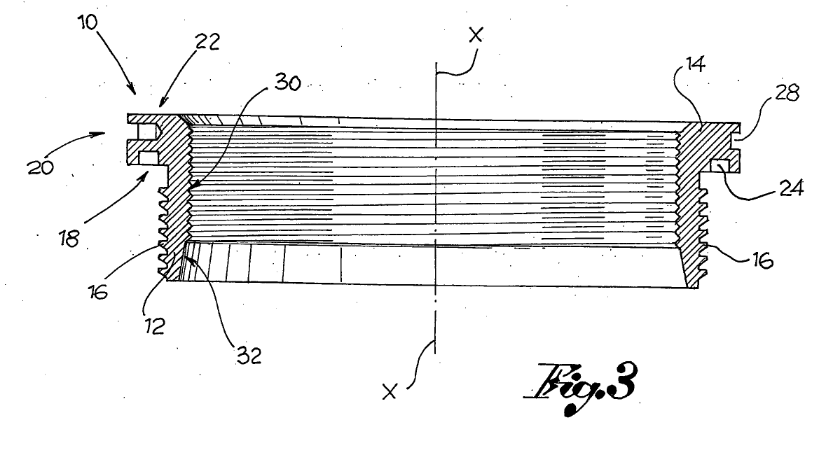

FIG. 3 shows a sectioned surface view of an insert of the tank in FIG. 1.

In accordance with the accompanying drawings, a tank for a water-treatment device is globally indicated with reference numeral 1.

The tank 1 comprises an internal coating 2, which extends prevalently along a longitudinal X-X axis, between a closed bottom and an opening area 6 with an opening 8 to the atmosphere.

In a variation of embodiment, said bottom can be made according to the characteristics illustrated below for said opening area 6.

In the description reported below, reference will be made to the terms “longitudinal” and “radial”, to be understood respectively as referring to the direction of said longitudinal X-X axis and a lying down direction on a perpendicular plane to said axis, cutting said axis.

The coating 2 comprises a wall of coating, between said bottom and said opening area, which is basically cylindrical, and surmounted by a cap wall 9a that culminates in a neck 9b, marking said opening 8, and projecting longitudinally from said cap wall 9a.

The coating 2 is made of a coating material that is compatible with water, in other words, a material that does not release fragments and cause processes of chemical deterioration, or release unwanted, harmful or similar substances, when it comes into contact with water, even after lengthy periods of time.

For example, said coating is made of a plastic resin, for example high-density polyethylene (HDPE) for alimentary purposes.

The tank 1 also comprises a hollow insert 10, connected to said coating 2 on a level with the opening 8 of this.

The insert 10 comprises an annular wall 12, for connecting said insert 10 to the coating 2, and a collar 14, connected to the annular wall 12, projecting externally from the coating 2, marking the opening 8.

The annular wall 12 preferably comprises gripping devices suitable for making a notch for connection between the coating 2 and the insert 10.

In a preferred embodiment, said gripping devices comprise at least one annular projection 16 that projects radially from said annular wall.

According to a preferred embodiment, said gripping devices comprise a variety of annular projections 16, spaced out longitudinally between each other and projecting radially from the annular wall.

The collar 14 preferably projects radially in relation to the annular wall 12 of the insert, defining a touching crown 18, an annular lateral surface 20 and a free crown 22.

The insert preferably presents an annular groove 24 on a level with said touching crown 18, which is suitable for holding a sealing ring 26.

Once the insert is connected to the coating 2, the touching crown 18 appears as the counterpart of the neck 9b of the coating 2.

According to an additional preferred embodiment, the insert presents an annular indentation 28 on a level with said lateral surface 20.

Internally, along said longitudinal X-X axis of the coating, from the outside towards the inside of the coating, the insert 10 presents a threaded part 30, which is suitable for connecting the tank 1 to a valve of the water-treatment device and an entrance part 32, flaring towards the inside of the coating 2.

The insert 10 is preferably made of a material that is harder than the coating 2 material.

For example, the insert 10 is made of a plastic resin, such as high-density polyethylene (HDPE) for alimentary purposes, for example with glass fibres.

Subsequently, the tank 1 comprises an external cover 40, which covers the coating, at least in part, since it is in close contact with this.

The cover 40 preferably comprises at least one bundle of fibres 42 that is wrapped tightly several times around the coating 2.

For example, said bundle comprises glass fibres.

Subsequently, said cover 40, comprises a matrix in which said bundle of fibres is buried.

Said matrix is preferably an isophthalic neopentilic resin, with the optional addition of colorant and filaments in glass fibre.

The cover 40 comprises a portion of covering 50 covering the collar 14 at least partially, which is in close contact with this, thus strengthening the connection between said insert 10 and said coating 2.

In particular, the portion of covering 50 penetrates into the annular indentation 28 of the insert 10, at least partially, further strengthening the connection between said insert and coating 2.

The tank 1 can be made according to a construction method, which envisages making the insert 10 separately from the coating 2, for example for pressing.

Said method also foresees a phase of production for the coating 2 connected to the insert 10.

Said phase can be carried out in a press for blowing, with a support for the insert 10, a relatively mobile die and a counter-punch, devices for blowing air into the cavity between the die and counter-punch in closed configuration and devices for feeding a soft tube between the die and counter-punch in open configuration.

In a variation of implementation of the method, said coating production phase can be carried out in a rotational press.

The insert 10 is positioned on the support between the die and the counter-punch; the sealing ring is inserted into the relative annular groove.

There is also a tube made of said coating material between the die and counter-punch, which is kept at a temperature suitable for keeping said coating material soft, in other words, in a physical state suitable for expansion for blowing and/or rotational.

The die and counter-punch are brought together, closing up.

On closing up, the die and counter-punch, cause the coating material to position itself around the annular wall 12 of the insert 10 held on the support.

By injecting blowing air inside the tube, between the closed die and counter-punch, said tube expands against the walls of the die and counter-punch until it takes the shape of the coating.

Said coating material penetrates between said annual projections of the annular wall 12 making the mechanical connection between the insert and the coating.

Subsequently, the touching crown 18 of the insert 10 presents itself in contact with the neck 9b of the coating 2, the sealing ring being thus held in the relative annular groove of the collar.

The coating connected to the insert is removed by opening the press, in other words, by distancing the die from the counter-punch.

Subsequently, a covering phase is carried out for the coating and the insert.

In other words, the covering 40 is made around the coating 2, repeatedly wrapping said bundle of fibres buried in said matrix tightly.

In particular, a part of said bundle of fibres is wrapped several times tightly around the collar 14, making said portion of covering 42.

Even more particularly, at the start of said covering phase, the bundle of fibres is wrapped several times around the collar 14 of the insert 10 and then continuously around the rest of the coating 2.

Unusually, according to the present invention, the tank presents a high resistance opening, suitable for resisting high working pressure or tank testing.

In other words, according to the present invention, the tank presents a longer working life and improved features of seal and resistance in time.

Particularly advantageously, the insert results strongly connected to the coating.

In order to have a thread that is sufficiently resistant to high pressure, in other words to prevent the thread from tearing, the insert is made of a harder material than that of the coating material.

This discontinuity of the mechanical features between the insert and the coating results in a tendency for the insert and coating to separate, which could lead to escapes or losses forming during operation.

In other words, said gripping devices create a notch suitable for holding the insert in place on the coating, but the circumferential projections of the annular wall and the coating material tend to come unstuck, creating preferential breather channels.

Advantageously, the portion of covering of the collar and the covering of the coating create a continual barrier, which prevents external leaks or losses.

Also advantageously, said matrix in which the bundle of fibres is buried, contributes to creating said continual barrier.

According to an additional advantageous feature, the portion of covering, which envelops the collar holds the insert and, in particular, it holds said collar in contact with said neck of the coating.

Advantageously, the sealing ring, positioned between said gripping devices of the annular wall and said portion of covering, prevents external leaks or losses.

According to an even greater advantageous feature, the covering increases the resistance of the coating also on a level with the cylindrical wall and said cap wall.

The bundle of fibres wraps the coating tightly, and the matrix in which it is buried, contributes to creating a compact layer, which opposes the action of the high pressure inside the coating, which is in a state of traction over the whole of the coating.

In other words, nonetheless, said bundle of fibres reacts in a way that can be compared to the metal rings associated with the walls of wooden barrels, in a uniform manner over the whole of the coating, guaranteeing the numerous aforesaid additional advantages.

It is clear that an expert on the subject can make alterations and variations to the above described tank in order to resolve unforeseen and specific requirements, which are moreover all included in the field of protection, as defined by the following claims.

1-22. (canceled)

23. Tank for a water-treatment device comprising:
an internal coating, which extends along a longitudinal axis, from a bottom to an opening area with an opening to the atmosphere;
a hollow insert, comprising an annular wall for connection to the coating, and a collar), connected to the annular wall, marking the opening of the coating, projecting externally from the coating;
an outside covering, which at least partially covers the coating, and which is in close contact with this;
wherein the covering comprises a portion of covering at least partially covering the collar, which is in close contact with this, reinforcing the connection between the insert and the coating.

24. Tank according to claim 23, wherein the insert comprises gripping devices suitable for making a notch for connection with the coating.

25. Tank according to claim 24, wherein the gripping devices comprise at least one annular projection projecting radially from the annular wall.

26. Tank according to claim 23, wherein the collar presents at least one annular indentation, which is penetrated by at least one piece of the portion of covering.

27. Tank according to claim 23, wherein the collar has an annular groove suitable for holding a sealing ring.

28. Tank according to claim 27, wherein the sealing ring is held between the collar and neck of the coating on which the collar corresponds.

29. Tank according to claim 23, wherein the insert has an internal threaded piece.

30. Tank according to claim 23, wherein the coating is made of a coating material and the insert is made of an insert material, wherein the insert material has a mechanical hardness that is greater than that of the coating material.

31. Tank according to claim 23, wherein the coating is made of high-density polyethylene for alimentary purposes.

32. Tank according to claim 23, wherein the insert is made of high-density polyethylene for alimentary purposes loaded with glass fibres.

33. Tank according to claim 23, wherein the covering comprises at least one bundle of fibre.

34. Tank according to claim 33, wherein the bundle of fibre is buried in a matrix, forming a continuous layer of wrapping.

35. Tank according to claim 34, wherein the bundle comprises glass fibres.

36. Tank according to claim 35, wherein the matrix is made of an isophthalic neopentilic resin.

37. Tank according to claim 23, wherein the covering is a continuous, airtight layer.

38. Device for water treatment comprising a tank, wherein the tank comprises
an internal coating, which extends along a longitudinal axis, from a bottom to an opening area with an opening to the atmosphere;
a hollow insert, comprising an annular wall for connection to the coating, and a collar), connected to the annular wall, marking the opening of the coating, projecting externally from the coating;
an outside covering, which at least partially covers the coating, and which is in close contact with this;
wherein the covering comprises a portion of covering at least partially covering the collar, which is in close contact with this, reinforcing the connection between the insert and the coating.

39. Device according to claim 38, also comprising a structure suitable for holding the tank, which is largely hidden from sight and suitable for holding water.

40. Method for manufacturing a tank, wherein the tank comprises
an internal coating, which extends along a longitudinal axis, from a bottom to an opening area with an opening to the atmosphere;
a hollow insert, comprising an annular wall for connection to the coating, and a collar), connected to the annular wall, marking the opening of the coating, projecting externally from the coating;
an outside covering, which at least partially covers the coating, and which is in close contact with this;
wherein the covering comprises a portion of covering at least partially covering the collar, which is in close contact with this, reinforcing the connection between the insert and the coating;
wherein the method comprises the phases of:
making the hollow insert;
making the coating, connected to the insert;
covering the collar with a portion of covering;
covering the coating, at least partially, with a covering, the portion of covering of the collar being continuous with the covering of the coating.

41. Method according to claim 40, wherein the phase of producing the coating connected to the insert comprises the phase of making the coating with a rotational press.

42. Method according to claim 40, wherein the phase of producing the coating connected to the insert comprises the phase that involves the implementation of a procedure for blowing a tube, part of the tube having being previously arranged around the annular wall of the insert to connect the insert to the coating.

43. Method according to claim 40, wherein the phase of covering the collar with a portion of covering comprises the phase of wrapping the collar with the portion of covering.

44. Method according to claim 40, wherein the phase of covering the coating with a covering comprises the phase of wrapping the coating, at least partially, with the covering.
